(19) United States
(12) Patent Application Publication
(10) Pub. No.: US 2010/0177624 A1
(43) Pub. Date: Jul. 15, 2010

(54) OPTICAL SYSTEM WITH A NUMBER OF RADIATION SOURCES

(75) Inventor: Alexander Padiy, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,724

(22) PCT Filed: Aug. 11, 2006
(86) PCT No.: PCT/IB06/52780

§ 371 Date: Feb. 13, 2008

(30) Foreign Application Priority Data
Aug. 16, 2005 (EP) 05300668.0

(51) Int. Cl. G11B 7/135

(52) U.S. Cl. 369/112.27; G9B/7

(57) ABSTRACT

The present invention relates to an optical system for reproducing and/or recording optically readable effects on an associated optical record carrier by means of a number of radiation sources. The number of radiation sources comprises a first radiation source capable of emitting a first radiation beam, and at least a second radiation source capable of emitting at least a second radiation beam. The system further comprises beam dividing means for separating at least the first beam into a first main beam and at least a first auxiliary beam, moreover the system comprises photodetection means capable of detecting reflected light from an associated optical record carrier, wherein the optical system is adapted to perform radial tracking from the reflected light of the at least first auxiliary beam being positioned in a first guard band comprised on the associated carrier, and wherein the number of radiation sources is less than or equal to the number of tracks.

### FIELD OF THE INVENTION

The present invention relates to an optical system for reproducing and/or recording optically readable effects on an associated optical record carrier by means of a number of radiation sources. The invention further relates to a method for reproducing and/or recording optically readable effects on an associated optical record carrier and to software for implementing the method.

### BACKGROUND OF THE INVENTION

In order to meet an on-going demand of increasing information storage capacity as well as speed, the available optical media, e.g. compact disc (CD), digital versatile disc (DVD) and the Blu-ray Disc (BD), constantly improve in both storage capacity and drive speed. Presently, the density limit reached by combining a track pitch of 240 nm with a channel bit length of 50 nm has shown that the capacity of the BD-type disc can potentially be increased from the current 23-25-27 GB up to 50 GB per layer of information on the media. However, an inherent conflict between further downscaling of the track pitch versus the need for stabile radial tracking at increasing operational speeds combined with limited cross-write/erase problems is encountered in present state of the art discs.

Recently two dimensional optical Storage (TwoDOS) has been demonstrated, see e.g. Alexander van der Lee et al. in Japanese Journal of Applied Physics, vol. 43, No 7B, 2004, p. 4912-4914. In the TwoDOS format information is written as a number of data rows in parallel along a broad spiral on a carrier, and the data is readout in parallel from the spiral using an array of laser spots. However, for write-once and rewriteable media this is not convenient because each laser spot has to be independently controlled which thus requires multiple lasers or laser cavities. This will complicate and increase cost of the corresponding optical devices. Similarly, the heat dissipation of such optical devices increases proportional to the number of lasers or laser cavities.

Hence, improved means for optical storage would be advantageous, and in particular a more efficient and/or reliable optical system for reproducing and/or recording optically readable effects on an associated optical record carrier would be advantageous.

### SUMMARY OF THE INVENTION

Accordingly, the invention preferably seeks to mitigate, alleviate or eliminate one or more of the above-mentioned disadvantages singly or in any combination. In particular, it may be seen as an object of the present invention to provide an optical system that solves the above mentioned problems of the prior art with both reliable reproducing and/or recording optically readable effects on an optical record carrier and increased storage density on the optical record carrier at high optical drive speed.

This object and several other objects may be obtained in a first aspect of the invention by providing an optical system for reproducing and/or recording optically readable effects on an associated optical record carrier, the system comprising:

a number of radiation sources, the number of radiation sources comprising:
a first radiation source capable of emitting a first radiation beam,
at least a second radiation source capable of emitting at least a second radiation beam, the at least second radiation beam comprising at least a second main beam and corresponding second main spot for reading information as readable effects in the carrier and/or recording information as readable effects on the carrier,

beam dividing means for separating at least the first radiation beam into
a first main beam and corresponding first main spot, for reading information as readable effects in the carrier and/or recording information as readable effects on the carrier, and
at least a first auxiliary beam, and corresponding at least first auxiliary spot, the auxiliary beam being applicable for radial tracking,

photodetection means capable of detecting reflected light from the optical record carrier,

the associated optical record carrier comprising, or being adapted for recording, readable effects arranged in tracks in one or more spiral(s), each of the one or more spiral(s) comprising a number of tracks being separated by one or more guard band(s),
wherein the optical system is adapted to perform radial tracking from the reflected light of the at least first auxiliary beam being positioned in a first guard hand, or on a track adjacent to the first guard band,
wherein the number of radiation sources is less than or equal to the number of tracks.

The optical system may be an optical system for use in such apparatuses as CD-players, DVD-players, BD-player, optical computer drives, etc.

The invention according to the first aspect is particularly but not exclusively advantageous for facilitating an optical system capable of recording/reproducing information at a high drive speed on a carrier with a low track pitch, i.e. track width. The possibility of a lowered track pitch does not jeopardise the radial tracking as the radial tracking is to be performed in the guard bands. The commonly used single optical storage system with a single spiral carrier format has an inherent conflict between the radial tracking provided by the groove and the wish to minimise the track pitch, a conflict that is solved by the present optical system. In addition the present invention provides a versatile optical system in which a number of radiation sources used for recording is decoupled from the number of tracks in the spiral. The present invention allows a trade-off between the cost, power dissipation and speed. This may be advantageous since different optical system implementation adapted for use on a given optical carrier format are allowed employing different number of radiation sources. In this way the disc capacity is decoupled from the drive speed, i.e. the reading and/or recording speed becomes a drive option rather than the format option.

The present invention employs a first and at least a second main beam and corresponding first and at least second main spots, for reading information as readable effects in the carrier and/or recording information as readable effects on the carrier, and at least a first auxiliary beam and corresponding first auxiliary spot; the auxiliary beam being applicable for radial tracking. One or more of the main beams, may however in a given embodiment, be used for tracking in addition to, or as an alternative to, the at least first auxiliary beam. An even more versatile system is thereby provided.

The optional features as defined in claims 2 and 3 describe advantageous embodiment since they provide cost effective ways of providing an optical system in accordance with the present invention. The at least first auxiliary beam may be a beam comprised in at least a first plurality of auxiliary beams. Optionally, may a first plurality of auxiliary beams and at least a second plurality of auxiliary beams be generated by the beam dividing means, where the at least first auxiliary beam being an auxiliary beam comprised in the first or at least second plurality of auxiliary beams. Consequently, in a given embodiment may a first radiation source give rise to a first main beam and corresponding first plurality of auxiliary beams, whereas a second radiation source may give rise to a second main beam and corresponding second plurality of auxiliary beams, and so forth if more radiation sources are employed.

Additionally, the present invention has the advantage that even though a number of radiation beams and a plurality of auxiliary spots may be directed onto the carrier, only a limited amount of the auxiliary spots, typically one or two auxiliary spots, and their respective reflected light beams are necessary for detection and generation of radial tracking control signals at any given moment in time. The radiation sources are fixed with respect to each other, and consequently it is only necessary to perform radial tracking by use of at least one suitable auxiliary beam, the auxiliary beam may be comprised in the first or at least second plurality of auxiliary beams. This is different from known multi-spot tracking methods in the field that require rather intensive means for photodetection and subsequent analysis of all of the reflected light beams. Advantageously, the present invention therefore may limit and/or simplify the necessary electronic circuitry for analysis of the reflected light from the auxiliary beams. In a situation where a number of auxiliary beams are employed in the tracking, a first auxiliary beam may be selected for tracking, however another beam may at a later stage be selected, e.g. in connection with selection of a different track. The new selected auxiliary beam may e.g. be selected from any of the generated auxiliary beams, or alternatively from a group of auxiliary beams.

The optional feature as defined in claim 4 may be advantageous since it provides a direct relation between the number of radiation sources and the speed of the drive for a particular carrier format.

The optional features as defined in claims 5 and 6 describe alternative advantageous embodiments. The optional feature as defined in claim 5 may be advantageous since it may facilitate a more simple and therefore cheaper and more robust construction, whereas the optional feature as defined in claim 6 may be advantageous since it may provide an embodiment where inter-radiation cross-modulation is avoided, or at least diminished.

The optional features as defined in claim 7 may be advantageous since by utilizing that a second auxiliary beam can be selected in order to change the track positions of the first and at least a second main beam, and subsequently perform radial tracking from the reflected light of the second auxiliary beam being positioned in the same or another guard band, a simple and robust way of changing the tracks for the number of radiation sources is provided.

The track changing of the main beam within a spiral may consequently in an embodiment be implemented by selecting the appropriate auxiliary beam for radial tracking, i.e. the changing of the track position from say track number one and two to track number three and four is effected by changing the auxiliary beam used for performing radial tracking from a first to a second auxiliary beam.

The optional feature as defined in claim 8 may be advantageous since by providing at least one photodetector corresponding to each auxiliary beam of the first plurality of auxiliary beams, an easy and robust way of separating the auxiliary beams is facilitated.

The optional feature as defined in claim 9 may be advantageous since by providing switching means for selecting the at least one photodetector that corresponds to the first or the second auxiliary beam for application in radial tracking it is possible to select relevant photodetector that corresponds to the first or the second auxiliary beam for application in radial tracking. Moreover it is possible to switch off the one or more photo detectors associated with detection of reflected light from auxiliary beams that are not applied in radial tracking. Also the corresponding electronic circuits e.g. amplification and/or pre-processing may be turned off. This provides the present invention with the advantage of reduced power consumption during operation and may additionally lower the system cost as the powering and/or cooling may be reduced. Furthermore, since not all photodetectors are in use, at least some of the pre-processing circuits (e.g. pre-amplifiers) can be shared between the different spots/photodetectors. Consequently, less electronics can be used and the system cost may be even further reduced.

The optional feature as defined in claim 10 may be advantageous since it may facilitate an easy lit between the position of the auxiliary spots and the tracks.

The optional feature as defined in claim 11 may be advantageous since by providing a number of auxiliary beams that is at least equal to the number of tracks in the one or more spiral(s), an auxiliary beam may be selected that always coincide with a guard band.

The optional features as described in claims 12 and 13 describe alternative advantageous embodiments. The plurality of auxiliary beams may be adapted to be disposed substantially symmetrical relative to the main beam on the associated optical record carrier. Additionally, the plurality of auxiliary beams may be adapted to be substantially equidistantly positioned on the associated optical record carrier. This may be achieved by a grating as the beam dividing means. A grating may however also provide asymmetrical diffraction. Recently, gratings with substantially equal intensity in diffracted spots have appeared. Such gratings may beneficially be applied within the context of the present invention.

In a second aspect, the present invention relates to a method of operating an optical system according to the first aspect of the invention, wherein the tracking, in a situation of use, is performed from the reflected light of at least a first auxiliary beam being positioned in a first guard band, or on a track adjacent to the first guard band, and wherein the number of radiation sources is less than, or equal to, the number of tracks.

In a third aspect, the invention relates to software executable on computing hardware for implementing a method of the second aspect of the invention.

This aspect of the invention is particularly, but not exclusively, advantageous in that the present invention may be implemented by a computer program product enabling a computer system to perform the operations of the second aspect of the invention. Thus, it is contemplated that some known optical system may be changed to operate according to the present invention by installing a computer program on a computing hardware controlling the optical system. Such software may be provided on any kind of computer readable medium, e.g. magnetically or optically based medium, or through a computer based network, e.g. the Internet.

The first, second and third aspect of the present invention may each be combined with any of the other aspects. These and other aspects of the invention will be apparent from and elucidated with reference to the embodiments described hereinafter.

### BRIEF DESCRIPTION OF THE FIGURES

Embodiments of the invention will be described, by way of example only, with reference to the figures, in which

FIG. 1 schematically illustrates an embodiment of an optical system and associated carrier,

FIG. 2 schematically illustrates two radiation sources, a light dividing means and the resulting main and auxiliary beams.

FIG. 3 is a schematic illustration of photodetection means,

FIG. 4 schematically illustrates carrier formats particularly suited for operation with the optical system according to the present invention,

FIG. 5 illustrates a situation where a single main spot is arranged substantially equidistantly along a spot line,

FIG. 6 illustrates symmetric configurations with 2 high-intensity spots and a number of low-intensity spots,

FIG. 7 illustrates asymmetric configurations with 2 high-intensity spots and a number of low-intensity spots,

FIG. 8 illustrates configurations with 3 high-intensity spots and a number of low-intensity spots, and

FIG. 9 illustrates configurations where cross-modulation are avoided.

### DESCRIPTION OF EMBODIMENTS

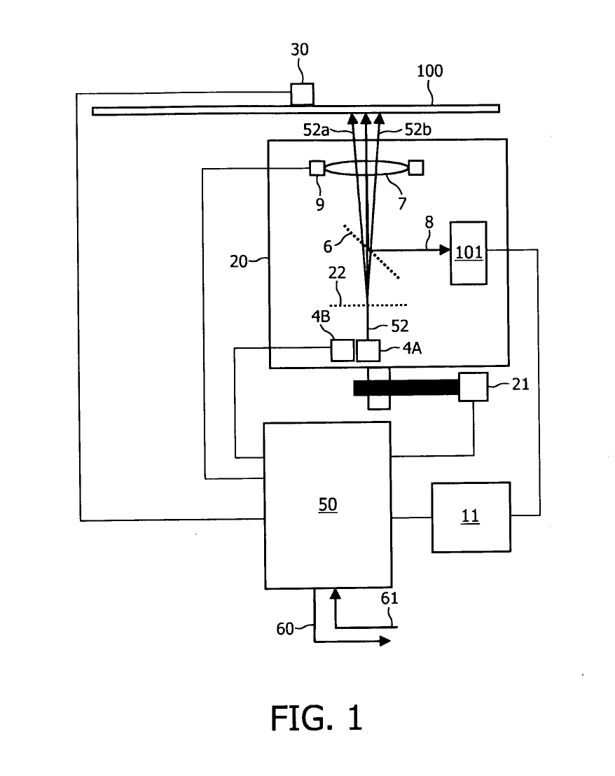

An embodiment of an optical system and associated carrier 100 is schematically illustrated in FIG. 1. The carrier 100 is fixed and rotated by holding means 30. The optical system comprises a number of radiation sources, the figure illustrates a first 4A and a second 4B radiation source. More than two radiation sources may be present, however only two are shown for clarity reasons. Furthermore, also for clarity reasons, is only one radiation beams 52 shown, it is however to be understood that each radiation source present in the optical system is capable of emitting a radiation beam. The radiation sources 4A, 4B can for example be semiconductor lasers with a variable power, possibly also with variable wavelength of radiation.

The carrier 100 comprises a material suitable for recording information by means of a radiation beam 52. The recording material may be of, for example, the magneto-optical type, the phase-change type, the dye type, metal alloys like Cu/Si or any other suitable material. Information may be recorded in the form of optically detectable regions, also called marks for rewriteable media and pits for write-once media, on the carrier 100.

The optical system further comprises an optical head 20, sometimes called an optical pick-up (OPU), the optical head 20 being displaceable by actuation means 21, e.g. an electric stepping motor. The optical head 20 comprises a photodetection system 101, a beam splitter 6, an objective lens 7, and lens displacement means 9. The optical head 20 also comprises beam dividing means 22, such as a grating or a holographic pattern that is capable of splitting on or more radiation beams into one or more main beams and a number of corresponding auxiliary beams. Here three components 52, 52a and 52b are shown, i.e. a high intensity main beam 52 and two low intensity auxiliary beams 52a, 52b. The reflected radiation 8 also comprises more than one component, e.g. the reflections of the three spots 52, 52a, and 52b, and diffractions thereof, but only one beam 8 is shown here for clarity. In the context of the present invention, a radiation source is understood to include any kind of radiation source capable of emitting radiation suitable for optical storage of information, such as infrared light (IR), visible light, ultra violet light (UV), X-rays etc.

It is contemplated that, in an alternative embodiment of the present invention, each of the radiation sources 4A, 4B and the beam dividing means 22 may be substituted by a plurality of radiation sources. One of the radiation sources may provide the main beam and the other light sources may provide the auxiliary beams. Possibly a combination of a plurality of light sources and one or more light dividing means, e.g. gratings, may be applied along the principles of the present invention.

The photodetection means may be a photodetection system. The function of the photodetection system 101 is to convert radiation 8 reflected from the carrier 100 into electrical signals. Thus, the photodetection system 101 may comprise several photodetectors, e.g. photodiodes, charged-coupled devices (CCD), etc., capable of generating one or more electric output signals that are transmitted to a pre-processor 11. The photodetectors may be arranged spatially to one another, and with a sufficient time resolution so as to enable detection of focus (FE) and radial tracking (RTE) errors in the pre-processor 11. Thus, the pre-processor 11 transmits focus (FE) and radial tracking error (RTE) signals to the processor 50. The photo detection system 101 can also transmit a read signal or RF signal representing the information being read from the carrier 100 to the processor 50 through the pre-processor 11. The read signal may possibly be converted to a central aperture (CA) signal by a low-pass filtering of the RF signal in the processor 50.

The optical head 20 is optically arranged so that the radiation beams 52 are directed to the optical carrier 100 via a beam splitter 6, and an objective lens 7. Additionally, a collimator lens (not shown) may be present before the objective lens 7. Radiation 8 reflected from the carrier 100 is collected by the objective lens 7 and, after passing through the beam splitter 6, falls on a photodetection system 101 which converts the incident radiation 8 to electric output signals as described above. The processor 50 receives and analyses output signals from the pre-processor 11. The processor 50 can also output control signals to the actuation means 21, the radiation source 4, the lens displacement means 9, the pre-processor 11, and the holding means 30, as illustrated in FIG. 1. Similarly, the processor 50 can receive data, indicated at 61, and the processor 50 may output data from the reading process as indicated at 60.

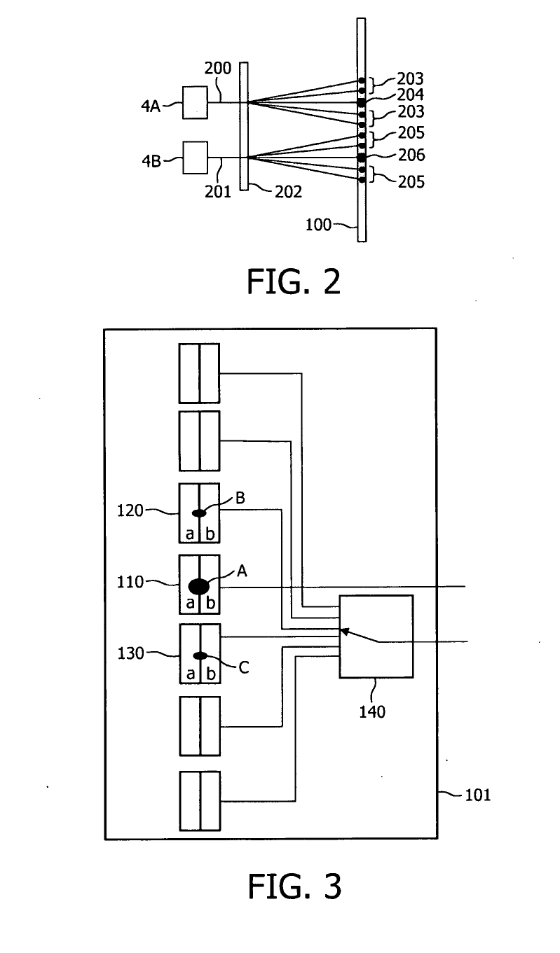

FIG. 2 schematically illustrates an embodiment where two radiation sources are directed to a single beam dividing means, resulting in two main beams and two pluralities of auxiliary beams. Two radiation sources emit a first and a second radiation beam 200, 201. A beam dividing means 202, such as a grating, separates the first and second radiation beams into a first and a second main beam 204, 206 and corresponding first and second main spots and a first plurality of auxiliary beams 203 and a second plurality of auxiliary beams 205, and corresponding first and at least second pluralities of auxiliary spots. In an alternative embodiment may only the first main beam be directed to the beam dividing means, so that at least a first auxiliary beam is generated, or possible a first plurality of auxiliary beams is generated.

FIG. 3 is a schematic illustration of an embodiment of photodetection means 101 suitable for use with respect to the present invention. A number of photodetector sections are shown, however one photodetector section may be present for each auxiliary beam of the first plurality of auxiliary beam, or even more photodetector sections may be present. On each of the photodetector sections 110, 120, 130, a corresponding spot, A, B, and C, respectively are shown. As indicated by the relative size of the spots A, B, and C, the spot A indicates the reflected light originating from the main spot whereas the spots B and C indicates reflected light from two auxiliary spots. In the embodiment shown in FIG. 3 are the photo detector sections 110, 120, 130 divided into two photo detectors a and b. This is the normal optical configuration for performing tracking by the push-pull (PP) method, where a relative weighting between the two detectors a and b is applied for generating a radial error signal denoting the error or deviation from an intended radial position and the actual position. Application of the present invention enables a switch or selector 140 that is adapted for selecting the appropriate auxiliary spot, in FIG. 3 spot B, for radial tracking by transmitting further the corresponding signal from photo detector section 120 to the pre-processor 11 and processor 50. The switch 140 is preferably an electronic switch, e.g. employing suitable transistor circuits, MEMS components etc.

However, the photo detector sections 110, 120, 130 may also apply the differential phase detection (DPD) method where the sections consist of four photodetectors. Note, that this embodiment requires that data is provided in the guard band(s). Similarly, the photodetector sections 110, 120, 130 can consist of a single photo detector for radial tracking by the differential central aperture (DCA) method. In the latter case, the present invention may be implemented by selecting a pair of first auxiliary spots, and selecting another second pair of auxiliary spots for radial tracking according to the present invention.

Radial tracking may be performed by use of a single auxiliary beam positioned in a guard band. A single auxiliary beam may be used for following a particular track within a multi-track spiral in the case where PP or DPD tracking error signal is used. When differential CA tracking error signal is used, two auxiliary beams are needed, the two auxiliary beams being placed on outer tracks adjacent to guard bands.

In order to follow any of the tracks within a multi-track spiral, a plurality of auxiliary beams may beneficially be employed, so that a suitable auxiliary beam, or suitable set of auxiliary beams, can be selected, e.g. upon selecting a given track. The number of auxiliary beams may be at least the number of tracks within the multi-track spiral for PP or DPD tracking, whereas at least the double amount of the number of tracks are needed for CA tracking.

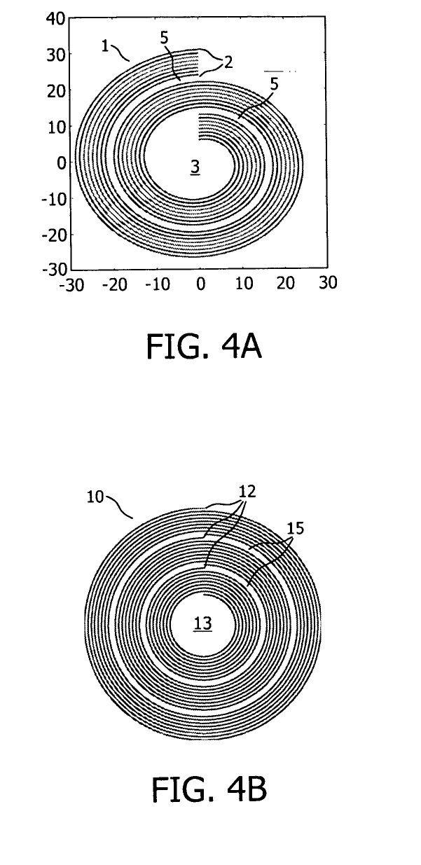

FIG. 4 illustrates particular formats of an optical carrier format that are well suited for being applied by an optical system according to the present invention. However, it should be stressed that the principle of the present invention is not limited to the shown formats.

FIG. 4A is a schematic drawing of a carrier format particular suited for operation with the optical system of the present invention. A plurality of tracks 2 are disposed substantially spirally and substantially concentrically with respect to central position 3 on the carrier. Each track 2 is adapted for recording and/or reproducing optically readable effects positioned substantially in a groove (not shown). Each plurality of tracks may be referred to as a meta track or a broad spiral track or simply as a broad track.

The plurality of tracks 2 are arranged adjacently in a broad spiral track 1 on the optical record carrier and the number of tracks in FIG. 4A is eight. The number of tracks 2 in the broad spiral 1 is determined by a compromise between the radial servo system complexity and the storage capacity decrease due to the fact that the guard band 5 contains no data or possibly that the data density in the guard band 5 is lower than in the grooves of the broad spiral. The number of tracks of a broad spiral may be such as: 2, 3, 4, 5, 6, 7, 8, 9, 10, 11, 12, 13, 14, 15, 16, 17, 18, 19, and 20. The tracking area 5 between the windings of the broad spiral track 1 is adapted for providing a radial tracking error signal from the optical carrier 100.

FIG. 4B is a schematic drawing of another carrier format particularly suited for operation with an optical system according to the present invention. A plurality of tracks 12 are disposed substantially spirally and substantially concentrically with respect to a central position 13 on the carrier. Each track 12 is adapted for recording and/or reproducing optically readable effects positioned substantially in a groove (not shown). The plurality of spirals 10 are arranged in concentric consecutive layers 12 on the optical record carrier with one spiral in each layer similar to the structure of an onion. FIG. 4B show only three consecutive spirals 12, but for an actual carrier the number of spirals 12 or “onion-shelves” may vary between 2 and 1.000.000.

An almost-zero push-pull signal, or generally a radial tracking error signal, not suitable for tracking will be obtained within the tracks of the broad spiral tracks 1 or within the consecutive spirals 12. In the guard bands, however, the groove structure has a significant lower frequency component due to the larger track spacing there, and the push-pull tracking signal from the auxiliary spot is strong and will provides a clear radial tracking error signal, such as an “S-curve” around the middle of a guard band 5, 15. As a consequence the auxiliary spots can reliably track the middle of the guard band 5 and 15 from the obtained radial tracking signal.

For Blu-ray optics, a guard band width down to 160-200 nm can be tolerated. The track pitch within the spiral can be chosen arbitrary as concerns the radial tracking system. In the rewritable and write-once systems the track pitch should be chosen large enough to prevent inter-track cross-write/cross-erase effects, while in the read-only system the track pitch should be chosen large enough to facilitate efficient mastering of the discs.

In a situation of 50% duty cycle, the duty cycle being the ratio between the groove width and the land width (or vice versa depending on the precise definition), the guard band width may be substantially equal to 1.5 times the track pitch. Such symmetric configurations where the optical system and the carrier format 1 and 10 are fitted together with respect to guard bands, track pitch and radial separation of the spots 52, 52a and 52b provides a particular advantage in connection with the present invention.

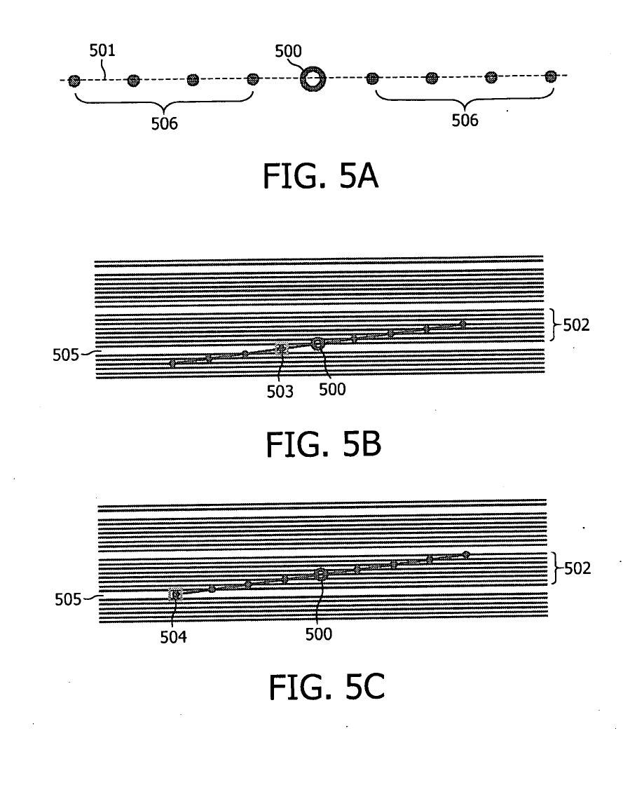

FIG. 5 illustrates a situation where a single main spot 500 and a single plurality of auxiliary spots is arranged substantially equidistantly along a spot line 501. Thus, on both sides of the main beam the auxiliary beams are separated by a fixed distance. In FIG. 5A is an example of a situation where a main spot is symmetrically arranged with respect to a plurality of auxiliary spots, here 8 auxiliary spots.

FIG. 5B illustrates the situation of FIG. 5A with the spots superimposed on a track section. The main spot 500 positioned at track #1 with in a particular broad spiral 502, whereas FIG. 5C illustrates the situation of FIG. 5A with the main spot 500 positioned at track #4 within the broad spiral 502. In both situations are the tracking performed by means of a first 503 (FIG. 4B) and a second 504 (FIG. 4C) auxiliary spot placed in the same guard band 505.

The FIGS. 5-9 illustrate embodiments where a plurality of auxiliary beams are generated by a beam dividing means for each of the main beams. It is however to be understood that the invention is not limited to these embodiments, since the optical system may generally be adapted to perform radial tracking from the reflected light of at least a first auxiliary beam being positioned in a first guard band, i.e. from only a single auxiliary beam.

Only a single radiation source and corresponding plurality of auxiliary spots disposed along single spot line is illustrated in FIG. 5. The present invention employs a number of radiation sources, giving rise to an increased reading and/or writing speed as compared to the situation of FIG. 5.

Having one radiation source per track, obviously would increase the reading and/or writing speed, such a solution however renders making the system little feasible for both commercial reasons and practical implementation because of the high cost and problems with power dissipation and heat.

The present invention deals with an intermediate solution; in which a number of radiation sources used for writing is decoupled from the number of tracks in the meta-spiral. This solution allows a trade-off between the cost, power dissipation and speed.

In order to increase the format efficiency, a meta-spiral with a relatively large number of tracks (6, 8, 9 or 12) may be used, but readout and writing is performed by means of a smaller number of lasers (2, 3 or 4). By using a meta-spiral disc format different drive implementations are allowed employing different number of lasers. A number of passes will be needed for accessing the whole meta-spiral if a small number of lasers is used. In case of the meta-spiral with 12 tracks, 3 passes will be needed in the case of 4-laser configuration, 4 passes with 3-laser configuration, 6 passes with 2-laser configuration.

The optical system of the present invention employs a number of high-intensity independently modulated main spots used for reading and/or recording and a number of auxiliary spots used for radial tracking.

In an embodiment where a diffraction grating is used for generating auxiliary spots, the diffraction grating creates imaginary laser sources, or auxiliary beams, in the optical plane of the real laser source and thus more light spots are formed on the disc surface due to these imaginary laser sources. In case of the grating with variable spot intensities, additionally to the real high-intensity laser source, a number of low-intensity imaginary laser sources are created by the diffraction grating.

By placing an additional real laser source at a position where one of the imaginary laser sources is located, i.e. by placing a second main spot at a position of an auxiliary spot relative to a first main spot, a multi-spot configuration with 2 independently modulated high-intensity spots and a number of low intensity satellite spots is achieved as illustrated in FIGS. 5-7 (high-intensity spots are visualized as being larger than the low-intensity spots in the FIGS.).

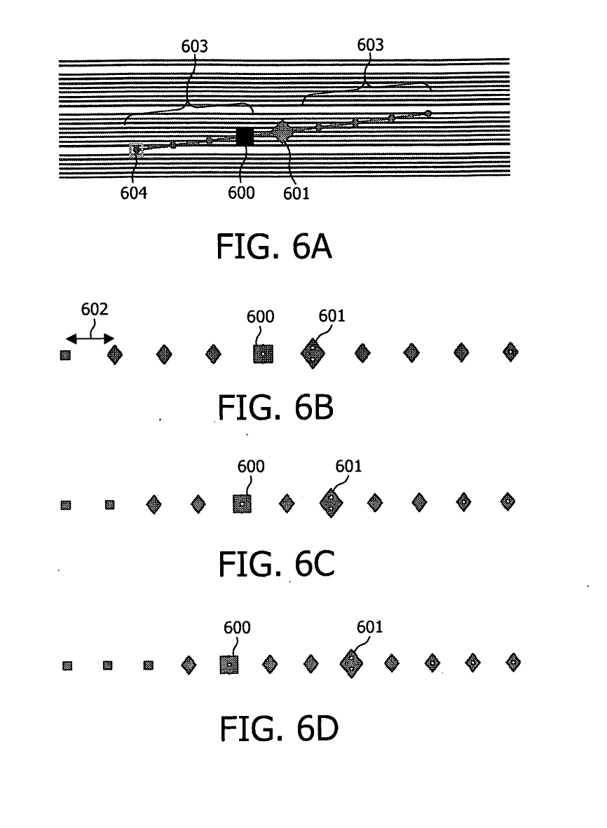

FIG. 6 illustrates symmetric configurations with 2 high-intensity spots 600, 601 and a number of low-intensity auxiliary spots 603. FIG. 6A illustrates a situation where a first main spot 600 is placed at track #4 and a second main spot 601 is placed at track #5. Radial tracking of the main spots is performed by tracking of the auxiliary spot denoted 604 so that the auxiliary spot follows the guard band. This situation corresponds to the situation as illustrated in FIG. 6B.

FIGS. 6B-6D illustrate situations where the spots are not superimposed on to a track configuration. In the three situations are two radiation sources employed. The first main spot 600 and the first plurality of auxiliary spots are arranged substantial equidistantly along a spot line on the carrier with a first separation distance 602. The second main spot and the at least second plurality of auxiliary spots are also arranged along the spot line, so that the first main spot and the second main spots are mutually displaced by an integral number of the first separation distance 602, the first and second main spots being disposed as neighbours in FIG. 6B, as next-neighbours in FIG. 6C, and as next-next neighbors in FIG. 6D. A configuration where the main spots are placed as neighbours may provide a simple scheme where consecutive groups of tracks in a broad spiral are followed, e.g. in a first pass, track #1 and #2 are followed, and in a second pass, track #3 and #4 are followed, etc. In a configuration where the main spots are placed as next-neighbours or further apart, groups of tracks are followed, e.g. as in a first pass, track #1 and #3 are followed, and in a second pass, track #2 and #4 are followed, etc. This may be advantageous in order to avoid or diminish e.g. thermal cross-talk between main spots (may especially be important during writing).

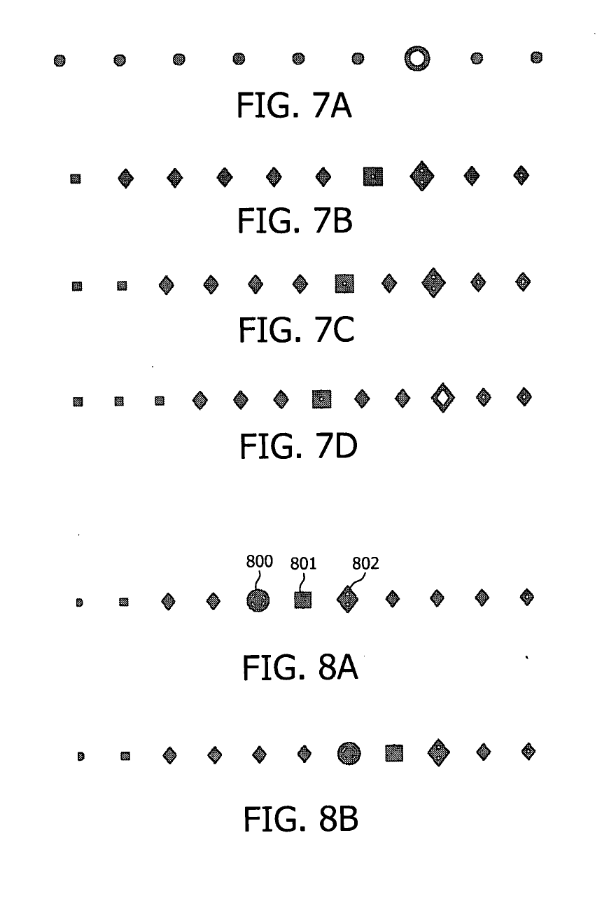

FIGS. 7A-7D illustrate similar spot configurations as in FIG. 6, except that the main spots are asymmetrically placed with respect to the respective auxiliary spots. FIG. 7A illustrates a situation where only a single main spot is placed asymmetrically with respect to the auxiliary spots, whereas FIGS. 7B-7D illustrate corresponding situations as those of FIGS. 6B-6D where two main spots are employed.

FIG. 8 illustrates a situation with 3 radiation sources giving rise to three main beams 800-802. FIG. 8A illustrates a situation where the respective main spots are configured symmetrically with respect to the respective plurality of auxiliary beams, whereas FIG. 8B illustrates a situation where the respective main spots are configured asymmetrically with respect to the respective plurality of auxiliary beams.

In the approach described above not a single laser source, but all of them contribute to the energy put into the high-intensity spots. However, the contribution of one of the lasers is much larger than that of the others since the diffraction grating attenuates the satellite spots strongly. Still, one should be aware of the small cross-modulation between the different lasers.

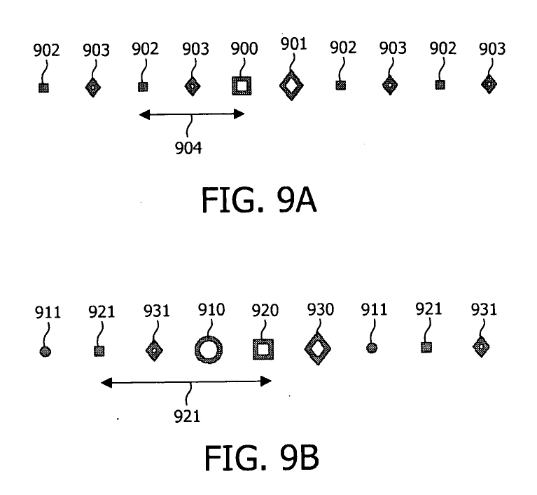

The above inter-laser cross-modulation problem can be eliminated, or at least diminished, if the additional laser sources are placed at a fraction of a distance between the real reference laser source and the imaginary laser sources created by the diffraction grating. FIGS. 6 to 8 illustrate configurations with 2 and 3 laser sources. In the case of 2 lasers, the additional laser should be placed exactly in between the real and the imaginary reference laser sources (or in between the two neighboring imaginary sources). In the case of 3 lasers, the distance between the sources should be divided in 3 equal intervals. The proposed scheme produces independently modulated high-intensity spots for writing and a number of weak satellite spots for radial tracking. FIG. 9 illustrates configurations where cross-modulation are avoided by mutually displacing the employed main spots by a fractional number of the separation distance 904, 912. FIG. 9A illustrates a configuration where two main spots 900, 901 are employed. None of the first main spot 900 and the corresponding auxiliary spots 902 are overlapped with any of the second main spot 901 and the corresponding auxiliary spots 903. FIG. 9B illustrates a configuration where three main spots 910, 920, 930 and corresponding auxiliary spots 911, 921, 931 are employed. Again none of the main and/or auxiliary spots overlap each other.

In a situation of use, a desired spiral can be selected by locating a first auxiliary spot on a particular guard band. The first auxiliary spot may be any suitable auxiliary spot e.g. for placing the first radiation source on the first track in the broad spiral. Desired tracks within the spiral can subsequently be selected by locating a second auxiliary spot at either the same or another guard band, the second auxiliary spot being any suitable spot for placing e.g. the first radiation source on the desired track. The correspondence between guard band, auxiliary spot and tracks, depend upon the particular format of the carrier and on the configuration of the optical system. The correspondence is known in advance and is incorporated in the operation system of the optical system.

Although the present invention has been described in connection with the specified embodiments, it is not intended to be limited to the specific form set forth herein. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1-15. (canceled)

16. An optical system for reproducing and/or recording optically readable effects on an associated optical record carrier (100), the system comprising:
a number of radiation sources, the number of radiation sources comprising:
a first radiation source (4A) capable of emitting a first radiation beam (200),
at least a second radiation source (4B) capable of emitting at least a second radiation beam (201),
beam dividing means (202) for separating the first radiation beam into
a first main beam (204) and corresponding first main spot (600), for reading information as readable effects in the carrier and/or recording information as readable effects on the carrier, and
a first plurality of auxiliary beams (203), and corresponding first plurality of auxiliary spots (603), and
for separating the at least second radiation beam into
at least a second main beam (206) and corresponding second main spot (601), for reading information as readable effects in the carrier and/or recording information as readable effects on the carrier, and
at least a second plurality of auxiliary beams (203, 205), and corresponding at least second plurality of auxiliary spots (603),
photodetection means (101) capable of detecting reflected light (8) from the optical record carrier,
the associated optical record carrier comprising, or being adapted for recording, readable effects arranged in tracks in one or more spiral(s) (2, 12), each of the one or more spiral(s) comprising a number of tracks being separated by one or more guard band(s) (5, 15),
wherein the optical system is adapted to perform radial tracking from the reflected light of at least a first auxiliary beam (604) being positioned in a first guard band, or on a track adjacent to the first guard band, the at least first auxiliary beam being an auxiliary beam comprised in the first or at least second plurality of auxiliary beams, and wherein a second auxiliary beam can be selected in order to change the track position of the first and at least a second main beam, the second auxiliary beam being an auxiliary beam comprised in the first or at least second plurality of auxiliary beams, and wherein the optical system is adapted to perform radial tracking from the reflected light of the second auxiliary beam being positioned in the same or another guard band, or on a track adjacent to the guard band,
wherein the number of radiation sources is less than or equal to the number of tracks.

17. An optical system according to claim 16, wherein the ratio of the number of tracks and the number of radiation sources is an integer.

18. An optical system according to claim 16, wherein the first main spot and the first plurality of auxiliary spots are arranged substantial equidistantly along a spot line (501) on the carrier with a first separation distance (602), and wherein the at least second main spot and the at least second plurality of auxiliary spots are arranged along the spot line, wherein the first main spot and the at least second main spots are mutually displaced by an integral number of the separation distance.

19. An optical system according to claim 16, wherein the first main spot and the first plurality of auxiliary spots are arranged substantial equidistantly along a spot line (501) on the carrier with a first separation distance (602), and wherein the at least second main spot and the at least second plurality of auxiliary spots are arranged along the spot line, wherein the first main spot and the at least second main spots are mutually displaced by a fractional number of the separation distance.

20. An optical system according to claim 16, wherein the photodetection (101) means comprises at least one photodetector (110, 120, 130) corresponding to each auxiliary beam of the first plurality of auxiliary beams.

21. An optical system according to claim 20, wherein the photodetection means comprises switching means (140) for selecting the at least one photodetector that corresponds to an auxiliary beam for application in radial tracking.

22. An optical system according to claim 16, wherein a separation distance in the radial direction between the plurality of auxiliary beams is substantially equal to an integer times the track pitch of the associated optical record carrier.

23. An optical system according to claim 16, wherein the number of auxiliary beams is at least equal to the number of tracks in the one or more spiral(s).

24. An optical system according to claim 16, wherein the first plurality of auxiliary beams are adapted to be disposed substantially symmetrical relative to the first main beam, and wherein the at least second plurality of auxiliary beams are adapted to be disposed substantially symmetrical relative to the at least second main beam on the associated optical record carrier.

25. An optical system according to claim 16, wherein the first main beam is adapted to be disposed substantially asymmetrical relative to the first plurality of auxiliary beams, and wherein the at least second main beam is adapted to be disposed substantially asymmetrical relative to the at least second plurality of auxiliary beams on the associated optical record carrier.

26. A method of operating an optical system (100) for reproducing and/or recording optically readable effects on an associated optical record carrier, the system comprising:
a number of radiation sources, the number of radiation source comprising:
a first radiation source (4A) capable of emitting a first radiation beam (200),
at least a second radiation source (4B) capable of emitting at least a second radiation beam (201),
beam dividing means (202) for separating at least the first radiation beams into
a first main beam (204) and corresponding first main spot (600), for reading information as readable effects in the carrier and/or recording information as readable effects on the carrier, and
a first plurality of auxiliary beams (203), and corresponding first plurality of auxiliary spots (603), and
for separating the at least second radiation beam into
at least a second main beam (206) and corresponding second main spot (601), for reading information as readable effects in the carrier and/or recording information as readable effects on the carrier, and
at least a second plurality of auxiliary beams (203, 205), and corresponding at least second plurality of auxiliary spots (603),
photodetection means (101) capable of detecting reflected light from the optical record carrier,
the associated optical record carrier comprising, or being adapted for recording, readable effects arranged in tracks in one or more spiral(s) (2, 12), each of the one or more spiral(s) comprising a number of tracks being separated by one or more guard band(s) (5,15),
wherein the tracking, in a situation of use, is performed from the reflected light of at least a first auxiliary beam (604) being positioned in a first guard band, or on a track adjacent to the first guard band, the at least first auxiliary beam being an auxiliary beam comprised in the first or at least second plurality of auxiliary beams, and wherein a second auxiliary beam can be selected in order to change the track position of the first and at least a second main beam, the second auxiliary beam being an auxiliary beam comprised in the first or at least second plurality of auxiliary beams, and wherein the optical system is adapted to perform radial tracking from the reflected light of the second auxiliary beam being positioned in the same or another guard band, or on a track adjacent to the guard band,
wherein the number of radiation sources is less than or equal to the number of tracks.

27. Software executable on computing hardware for implementing a method as claimed in claim 26.
